(19) United States
(12) Patent Application Publication
(10) Pub. No.: US 2018/0139171 A1
(43) Pub. Date: May 17, 2018

(54) SYSTEMS, APPARATUSES AND METHODS FOR TRACKING ASSETS USING DOMAIN NAME SYSTEM SIGNALING

(71) Applicant: Armada Logistics, Inc., Boston, MA (US)

(72) Inventors: Konstantin Klitenik, Cambridge, MA (US); Marc Held, Boston, MA (US)

(21) Appl. No.: 15/816,650

(22) Filed: Nov. 17, 2017

Related U.S. Application Data
(60) Provisional application No. 62/423,588, filed on Nov. 17, 2016.

(51) Int. Cl. H04L 29/12; H04W 64/00

(52) U.S. Cl. CPC H04L 61/1588; H04W 64/006; H04L 61/2592; H04L 61/1511

(57) ABSTRACT

Systems, apparatuses and methods for tracking the locations of mobile asset(s). An exemplary system may include a module physically associated with a mobile asset and a remote server that communicates with the module via access point(s) providing access to a communication network including a domain name server. The module may scan for broadcast(s) by a first access point, the broadcast(s) including a first broadcast incorporating a first identifier associated with the first access point; determine a signal strength associated with the broadcast(s); encapsulate into DNS request packet(s) data incorporating the first identifier and the signal strength; and communicate, using DNS tunneling, the DNS request packet(s) to the remote server via the access point(s) and the domain name server. The remote server may estimate the location of the module based on the data incorporating the first identifier and the signal strength received in the DNS request packet(s).

### RELATED APPLICATION(S)

This application claims the benefit of priority to U.S. Provisional Application No. 62/423,588 filed Nov. 17, 2016, which is incorporated herein by reference.

### TECHNICAL FIELD

The present invention is directed to systems, apparatuses and methods for tracking the locations of assets. It is particularly, useful for tracking the location of mobile assets, such vehicles, containers, pallets, and items shipped therewith, as they move through shipping systems.

### BACKGROUND

Managing the flows of long-distance supply chains is an area of increasing interest to corporations, given global economic integration. In particular, systems for the real-time location tracking of containers, pallets, packages, vehicles, and the like are used for tracking asset movement to enable better management. Real-time asset tracking offers numerous opportunities for increasing profitability: examples of these opportunities include (1) improved estimates of delivery time, (2) more accurate just-in-time inventorying, (3) enabling of corrective action if anomalous asset movements are detected (e.g., delay or diversion), (4) increased shipping velocity enabled by accurate analysis of asset movement patterns, and (4) performance characterization of alternative routes, shippers, packaging technologies, management algorithms, and other aspects of the asset movement system.

Computer applications for asset tracking can be provided as products or as services (e.g., Software as a service (SaaS)) and normally are provided with a standalone application or access to a server that can show the position of a given package or its collocated pallet, container, or vehicle on a map and, in some cases, calculate various performance metrics. These systems usually support geofencing, route monitoring, and customizable alarms.

In general, asset tracking can be direct (e.g., scanning of barcode tags) or wireless (e.g., radio pinging of tags attached to or integrated with products, vehicles, containers). Wireless asset tracking is likely to dominate the industry going forward because it has the potential to be low labor and high accuracy and does not require that assets be individually accessed by workers or passed through machines so as to enable tag-scanning or other close-range identification procedures. Wireless asset tracking methods depend on telecommunications technologies that allow each asset's location to be determined with sufficient accuracy and frequency (e.g., continuously, periodically, or opportunistically). For example, global navigation satellite system (GNSS) technology and cell-phone signaling have been developed for asset tracking.

However, per-asset cost is relatively high for the existing tracking technologies. For example, GNSS tracking can only justify its cost for relatively valuable assets such as trucks or intermodal shipping containers, while the payback from GNSS tracking of a typical shipping pallet, relative to the modest value of the pallet and its contents, is not high enough to justify the added cost. The same is true of other telecommunicative asset-tracking schemes presently on the market.

There is therefore a need for an asset-tracking approach that enables tracking of assets moving through global transport systems in a manner that has low infrastructure requirements and is (a) wireless, (b) automatic, (c) sufficiently resolved in both space and time, and (d) sufficiently low-cost to enable profitable tracking of lower-value assets than has hitherto been feasible, as well as of more-valuable assets.

### SUMMARY

Herein are disclosed systems and methods for automatic wireless asset tracking via opportunistic signaling through network access devices. In various embodiments, the invention employs DNS tunneling to enable two-way communications between mobile tracking and/or monitoring modules (“module(s)”) and a back-end computational capability embodied in, for example, a server. A module is physically linked to given asset (e.g., affixed to a shipping pallet, placed within or upon a container and/or a vehicle). By determining the unique identifiers of network access transceivers in the vicinity of a module at a specific time and comparing these identifiers with locational information in a database, the invention enables the module's location at a given time to be estimated. Repeated location estimates enable mapping of the Module's motion over time. Other information pertinent to location (e.g., received signal strength indication [RSSI] measurements, inertial navigation data) may also be uploaded by modules, as may non-locational information (e.g., asset temperature, vibration and shock measurements, security system status). Location and other information may be used by system operator or client to characterize shipment dynamics in a large number of possible ways, which in turn enable higher efficiency.

Various embodiments of the invention overcome limitations of the prior art. For example, a module typically comprises a relatively low-power, low-cost, short-range, wireless communications device along with relatively slight capabilities for power, computation, timekeeping, and memory, keeping module cost relatively low. Opportunistic exploitation (i.e., use) of existing transceivers and communications network capabilities obviates the need to build application-specific infrastructure (e.g., install transceivers at transshipment or transloading facilities), reducing overall system cost.

In a preferred embodiment, the wireless network access devices utilized by the invention are WiFi access points (APs) and the network accessed through the APs is the Internet. In this illustrative embodiment, the system exploits (i.e., uses) preexisting WiFi infrastructure (e.g., APs within range of a warehouse) to communicate with the system's back end (e.g., a server) via DNS tunneling. The Domain Name System (DNS) is a decentralized, hierarchical naming and lookup system for resources connected to a network such as the Internet. One function performed by the DNS is association of domain names (strings of alphanumeric characters) with the corresponding numerical Internet Protocol (IP) addresses of individual devices, to which messages can be uniquely directed. That is, the DNS provides a distributed directory service that links names (“what one is looking for”) with IP addresses (“where it is”). Because the DNS entails the two-way exchange of information packets between devices and servers, it can be exploited (i.e., used) to transmit information bidirectionally (albeit slowly) for purposes other than IP lookup. This well-known practice is termed “DNS tunneling.” The present invention applies DNS tunneling techniques for shipment tracking.

In an example of DNS function, a device transmits a string termed a “DNS query.” A DNS query comprises up to N substrings (“labels”), whose query size is less than 256 bytes. Each label is limited to 63 characters. Thus, an exemplary query has the general (simplified) form label3.label2.label1.domain2.domain1, where label1, label2, and label3 are arbitrary strings, usually subdomain names, domain2 is a second-level domain name (e.g., “armada”), and domain1 is a top-level domain name (e.g., “org”). The DNS server hierarchy, upon receiving a DNS query, seeks to “resolve” the query by recursively discovering within the hierarchy a server that knows the IP address associated with the full domain name. A DNS tunneler requests resolution of “domain names” that are in fact arbitrary data strings that cannot be resolved to IP addresses by the standard DNS hierarchy, or that are surpassingly unlikely to be so resolved. Such a request results in its own transmission to the bottom of the hierarchy, namely a private DNS server, also herein termed the “Location Service Server,” running a tunneling client. The Location Service Server is the tunnel endpoint and is sometimes characterized as a “fake” (or “custom”) DNS server: it extracts the data content (label1, label2, label3) of the incoming request.

Moreover, a message termed a “DNS reply” may be sent by the Location Service Server to the device that sent the original DNS request. A DNS reply can also be used to encapsulate data, which a receiving device may interpret as data (e.g., configuration parameters values, operational commands). One type of DNS Reply that can be used to encapsulate data is “A Record”, meaning address, which is simply an ip address. Another type of DNS Reply that can be used to encapsulate data is CNAME, which requests that the querying client redo the query for the supplied name. The format for CNAME reply is essentially the same as the query and the same type of encoding can be used to send the data back. Yet another type of DNS Reply that can be used to encapsulate data is TXT (text), which can be an arbitrary string of text data. In various embodiments of the invention, DNS reply messages are sent to modules to confirm receipt of uploaded information, request re-transmission, configure settable states of the Module, or perform other functions.

DNS tunneling permits establishment of two-way communications between any two devices connected to the Internet (or to any network comprising a DNS server hierarchy). Various embodiments of the invention exploit (i.e., use) DNS tunneling, together with location identification of network access points, to enable asset tracking. Herein, “asset tracking” signifies not only tracking of physical asset location but also, potentially, acquisition of non-locational information pertinent to an asset and transmission of various types of information from an outside source to the module associated with a given asset. Information transmitted to a Module may be further transmitted thence, in some cases, to other devices (e.g., sensors), either in a wired or wireless manner. In an example, a module comprises or is in contact with one or more sensors that collect information about a given asset and its environment.

Although some network managers seek to detect and restrict abusive DNS tunneling by detecting DNS over-use by single hosts, using character frequency analysis to distinguish encapsulated data from authentic subdomain names, or by other means, DNS is a widely used tool and networks are unlikely to shun or even detect Modules that use DNS tunneling to communicate a relatively modest amount of information. In an illustrative use case, a Module completes a scan report by transmitting between 1 and 10 DNS requests and receiving a similar number of replies. In other instances, more or less DNS requests may be transmitted. In addition, a cap may be placed on the number of DNS requests that can be sent during a wake period of the module.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 schematically depicts an illustrative system for location tracking of assets in, for example, shipment systems.

FIG. 2 is a flow chart describing operational states of the asset-tracking system of FIG. 1.

FIG. 3 is a depiction of portions of the asset-tracking system of FIG. 1 and of data flows within the system

### DETAILED DESCRIPTION OF THE EMBODIMENTS

In accordance with certain embodiments, systems and methods are disclosed that enable wireless asset tracking in transport and shipment systems partly through the opportunistic exchange of DNS messages through extant, non-dedicated telecommunications infrastructure. Locational and other information are obtained concerning assets and configuration data and other data are transmitted to tracking and/monitoring modules associated physically with distinct assets.

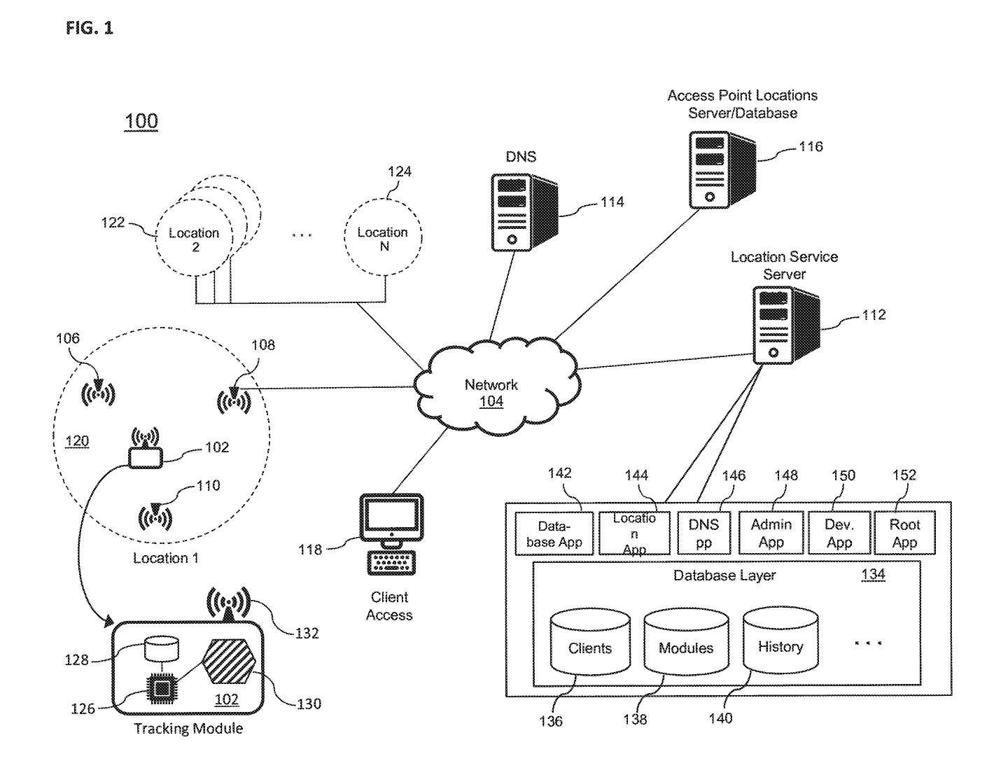

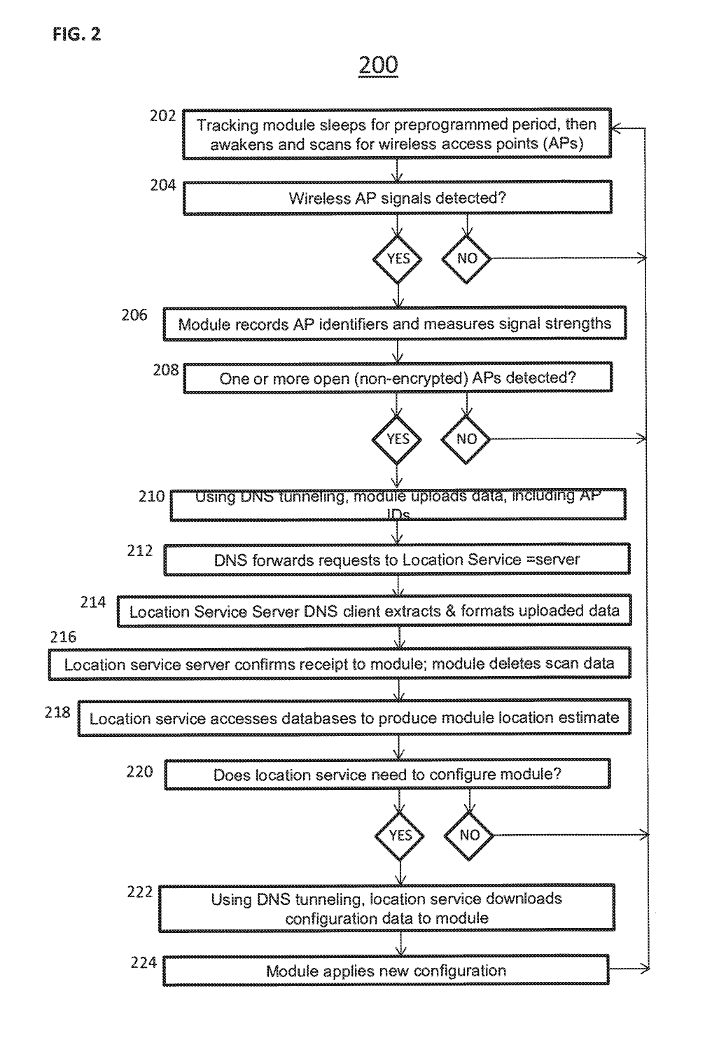

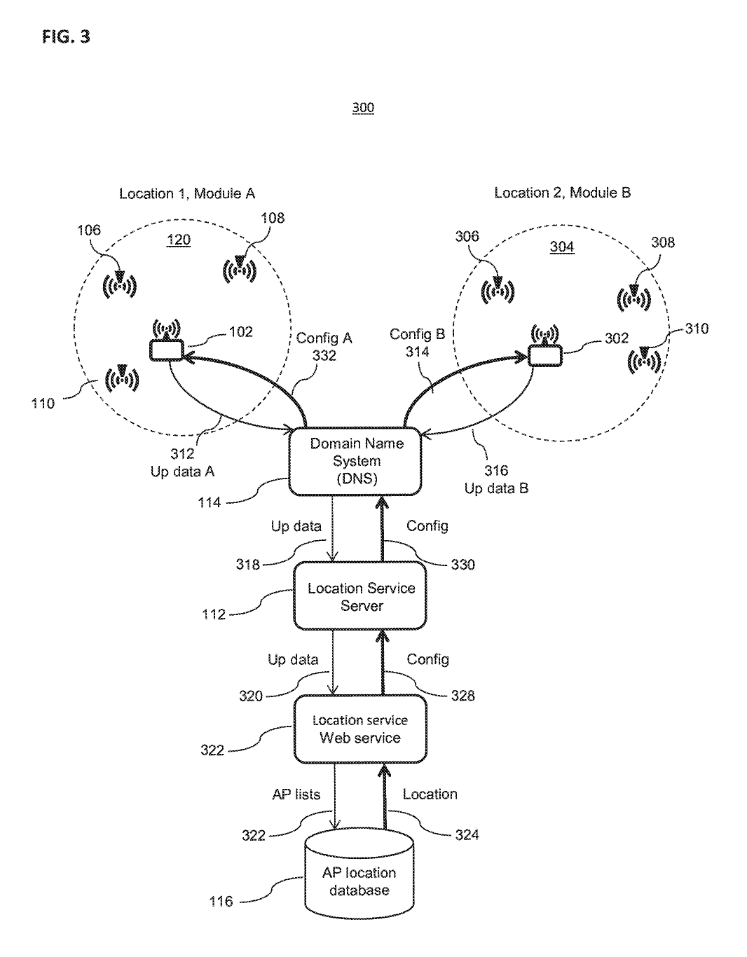

FIG. 1 schematically depicts portions of an asset-tracking system 100 according to an illustrative embodiment of the invention. System 100 comprises one or more tracking and/or Monitoring Modules 102, a telecommunications network 104, one or more Access Points (APs: e.g., APs 106, 108, 110) that are in communication with the Network 104, and a back-end Location Service Server 112. In an example, the APs are WiFi access transceivers and the Network 104 is the Internet. The Network 104 comprises or is in communication with a server hierarchy implementing a Domain Name System (DNS) 114, symbolized in FIG. 1 by a single server. The Network 104 is also in communication with the Location Service Server 112, an Access Point Locations Server/Database 116, and a Client Access interface 118 whereby a client may receive information and issue commands as authorized. The functioning of System 100 will be clarified with reference to FIG. 2 and FIG. 3; the purpose of FIG. 1 is to depict an illustrative inventory of components arranged in an illustrative topology.

In the state of operation of System 100 that is depicted in FIG. 1, the Module 102 is at a given spatial location, Location 1 (120). The spatial extent of Location 1 is, for the purposes of system 100, that region within which the Module 102 can wirelessly exchange digital packet communications. The number of APs at a Location can range from 0 to any higher integer, as can the number of Locations and the number of Tracking and/or Monitoring Modules at each Location. In an example, Location 120 is a warehouse and possibly the immediate vicinity of the warehouse, and there at three APs at the Location 120, as depicted. In FIG. 1, APs at N−1 other Locations, e.g., Location 2 (124) through Location N (126), with ellipses indicating Locations not explicitly depicted, are in at least intermittent contact with the Network 104. Any given Module (e.g., Module 102) may be stationary or in motion; in the state of operation depicted in FIG. 1, it is assumed for simplicity that if the Module 102 is in motion (e.g., on a moving truck), the population of APs accessible to the Module 102 remains sufficiently stable for an interval long enough to enable the successful exchange of locational and other information through the Network 104, as described hereinbelow. Data transfer between discrete devices depicted in FIG. 1 is typically via the Network 104, although non-network interdevice communications are not ruled out.

Each Tracking Module 102 comprises a computational capability 126, a memory capability 128, a communications and media interface 130 that handles communications with the APs and with entities reached via DNS tunneling (e.g., the Location Service Server 112), and a physical transceiver capability 132. The memory capability 128 typically will store a software application that executes on the computational capability 126 and implements the functions of the Module 102; the memory capability 128 will also store results of scans for APs, parameter configuration settings for the Module 102, and data from sensors and other sources. The computational capability 126 will typically comprise a timekeeping capability and may comprise capabilities for exchanging commands and data with devices not depicted in FIG. 1. Power storage and conversion components, sensors, and other components (not depicted) may also be comprised by a module. The transceiver 132 may be a WiFi transceiver, a Bluetooth transceiver, or some other type of wireless transceiver, and may comprise one, two, or more wireless transceivers of various types. The module subsystems just described are illustrative, not restrictive: various embodiments comprise subsystems that depart from this description, while ultimately providing equivalent services.

Each module (e.g., Module 102) is physically associated with a mobile asset (not depicted), e.g., pallet, container, package, or vehicle, for at least the duration of a particular shipping event. Herein, a “shipping event” can be an end-to-end journey of an asset or a portion of such a journey, and may include periods both of movement and of residence at transshipment, transloading, or storage facilities. Physical association of the Module with its asset is accomplished by affixing the Module to, or integrating it with, some portion of the asset.

The Location Service Server 112 is a computing device (e.g., laptop, desktop, tablet) capable of storage, retrieval, and generation of data pertaining to the operation of the system 100. In various embodiments, the Location Service Server 112 is not a unitary computing device (e.g., desktop computer); that is, its computational and data-storage capabilities may be realized by multiple devices, either redundantly or in a distributed (e.g., cloud-computing) manner. Thus, no restriction is intended by the representation of the Location Service Server 112 as a unitary device in FIG. 1. The Location Service Server 112 comprises a database layer 134 that implements access to one or more databases, e.g., a Clients database 136 (recording asset identification and other information pertaining to particular asset owners), a Modules database 138 (recording configuration and other information pertaining to individual Modules), a History database 140 (recording information pertaining to past operations of the system 100), and potentially other databases, indicated in FIG. 1 by ellipses, which may contain any data deemed pertinent to the conduct of the system 100 (e.g., measured characteristics of various routes, carriers, management strategies, and the like).

The Location Service Server 112 also comprises software programs that implement various functional aspects of the system 100. These programs can include a database app 142, which maintains the contents of the database layer 134 and retrieves information for serving to Modules and other devices as needed; a Location app 144, which algorithmically estimates Module locations based on various data types; a DNS client app 146, which handles DNS tunnel encapsulation and decapsulation and other DNS-specific tasks; an administrative app 148, which enables a master user to act at an operations management level; a developer app 150, which enables access to the application programming interfaces of the system for application development; and a root app 152, which enables master control over other user categories and access to everything contained in the database layer 134. In various embodiments, the functions realized in the illustrative system 100 by the database layer 134 and the apps 142, 144, 146, 148, and 150, as well as other apps that may be comprised by the Location Service Server but are not depicted in FIG. 1, are realized by a differently organized set of applications or software modules. Moreover, the databases comprised by the database layer 134, and/or other databases comprised by the Location Service Server 112, are not necessarily stored in a single memory device, but may be stored in a distributed and/or redundant manner over a number of hardware devices. The server subsystems just described are illustrative, not restrictive: various embodiments comprise subsystems that depart from this description, while ultimately providing equivalent services.

FIG. 2 is a flow chart schematically depicting an operational procedure 200 of the illustrative system 100 of FIG. 1. The procedure 200 is illustrative, not restrictive: actual procedures may contain more, fewer, and other steps than those depicted in FIG. 2.

In a first step 202, the Module 102 of FIG. 1 awakens itself (i.e., becomes active), triggered by completion of a pre-programmed time interval, from a low-power or “sleep” state and scans for detectable APs at its present location. If no AP is detected (step 204), the Module 102 goes back to sleep for another preprogrammed time interval. If one or more APs are detected (step 204), the Module 102 records in its memory capability (step 206) the distinctive identification codes broadcast by the detected APs and also determines and records an RSSI for each AP (i.e., a measurement of the signal strength of each AP, which is a function of distance from the AP to the Module 102 and of other factors). The Module 102 may, in various embodiments, also acquire and record the time and/or data from sensors or devices that are incorporated within it or with which it is in communication (e.g., a GPS unit, temperature sensors embedded in an asset payload), and the computational capability of the Module may take various actions in response to such data. Herein, the body of data that the Module acquires upon awakening, and which it is programmed to upload opportunistically to the Location Service Server 112, is termed a “scan.” A scan typically includes Module identifier information. After recording AP identifiers, RSSIs, and in some instances other data, Module 102 then determines (step 208), using standard protocol-defined operations, whether any of the detected APs are non-encrypted. If all detected APs are encrypted, DNS tunneling cannot occur the Module 102 goes back to sleep for another preprogrammed time interval.

If one or more APs are non-encrypted, the Module 102 selects one of the non-encrypted APs and uploads (step 210) its scan data to the DNS 114 using standard DNS tunneling techniques. In particular, the Module 102 encapsulates its scan data in one or more DNS request packets. In various embodiments, the Module 102 sends all DNS requests through a single AP (e.g., that with the strongest RSSI) or distributes transmission of its DNS requests among two or more APs in order to minimize the likelihood of blocking. Also in various embodiments, well-known techniques for assuring integrity and security of data (e.g., encryption, error correction coding) are applied to the data that is to be encapsulated and tunneled.

The DNS 114, by its routine operations, seeks to resolve each of the request messages sent from the Module 102. The domain structure of request messages, further clarified below with reference to FIG. 3, is designed to assure ultimate delegation (step 212) of each request by the DNS to the Location Service Server 112, where a resident DNS client app decapsulates each request (i.e., its tunneled data content extracted), assembling and formatting the extracted messages as appropriate (step 214). The Location Service Server 112 sends (step 216) a series of one or more DNS reply messages back to the Module 102 via the DNS Server 114; these messages confirm receipt of the DNS requests sent by the Module 102. Upon receipt of the reply messages, the Module 102 deletes (also step 216) from its memory capability 128 the scan data whose successful transmission has been confirmed.

The Location Service Server 112 now accesses one or more databases (step 218) to determine the locations of the one or more APs reported in the scan from the Module 102. For example, when the APs in question are WiFi APs, geographical location information can be obtained from commercially extant sources such as Google or Skyhook, Inc. For example, AP identifiers and RSSI measurements can be transmitted to the commercial location source, which responds with a location estimate for Module. The Location Service Server may perform additional processing (also step 218) to refine an estimate of Module location. This typically would entail an algorithmic procedure, or example, one that resolves contradictory or anomalous location data, uses previous location estimates to refine new ones in a Bayesian manner, incorporates additional sensor data from Modules (e.g., inertial tracker data), or otherwise computes or refines location and location-related parameters based on a range of data types. In an example, AP identifiers alone suffices to show that the Module 102 is at a particular facility (e.g., transshipment facility). In another example, AP identifiers combined with RSSI data enable estimation of where the Module 102 is in the particular facility. In another example, non-locational information tunneled from the Module 102 is used to estimate asset condition (e.g., temperature, orientation, other). In yet another example, information on a shipment method from the History database 140 is combined with current and recent Module location information, possibly including information about other Modules currently in transit, to refine predictions of asset movement.

The Location Service Server 112 takes appropriate action based on its estimates of location and possibly other characteristics of an asset. For example, it may update a progress map in its History database 140; alert a client of misrouting, possible theft, or other problems with an asset; alert a client of an updated time-of-arrival estimate; alert a client of asset arrival; or take other actions. If data are not received from a Module in a predetermined window of time, the Location Service Server 112 may alert an operator to begin a verification-of-status procedure to verify the fate of an asset.

The Location Service Server 112 may, based on various factors, decide (step 220) to change the configuration of a given Module, e.g., to change the length of the Module's sleep interval. Such messages are preferably transmitted to Modules during intervals of Module wakefulness. If no Module reconfiguration is desired, the Module 102 is either commanded via a DNS reply message to go back to sleep for another preprogrammed time interval, or is allowed to go back to sleep after a preprogrammed timeout. If reconfiguration of the Module 102 is desired, an appropriate formatted DNS return message is sent (step 222) to the Module 102 via DNS tunneling, and the Module applies the new configuration (step 224). In one example of a reconfiguration of Module 102, a Text based DNS reply message may be sent by the Location Service Server 112 to the Module 102. A portion of this message could include the following:

“600,n,10,aabbccddeeff,password,gghhiijjkkll,password”.

By way of example, this portion of the message may be interpreted by the Module 102 as an instruction to: scan for APs every 600 seconds, not update its firmware, scan for a maximum of 10 access points when undertaking a scan, and use the provided password for accessing a particular AP having a specified MAC address. However, the number of seconds or access points may vary depending on the reconfiguration. Similarly, the message could require a firmware update or specify the use of a different password. In addition, the above-mentioned parameters may be separated by commas or not at all. The Module 102 may also confirm receipt of reconfiguration information via one or more DNS request messages. (step not shown). After reconfiguration, the Module 102 will typically put itself to sleep for another preprogrammed time interval.

FIG. 3 is a schematic depiction of information flow among some of the components of a System 300 similar to system 100 of FIG. 1. In system 300, a first or “A” Module 102 at a first location, Location 1 (120), detects three APs (106, 108, 110). A second or “B” Module 302 at a second location, Location 2 (304), detects three APs (306, 308, 310). Information movements in system 300 are depicted in 300 by lighter arrows (“up” flow) and darker arrows (“down” flow); i.e., upload from Module 102 is depicted by light arrow 312, and download from Module 302 is depicted by dark arrow 314.

In an example, the APs 106, 108, 110 of Location 1 (120) are WiFi APs uniquely identified by the media access control (MAC) addresses 00:00:00:00:01, 00:00:00:00:02, and 00:00:00:00:03, respectively, while the APS 306, 308, 310 of Location 2 (304) are WiFi APs having MAC addresses 00:00:00:00:04, 00:00:00:00:05, and 00:00:00:00:06, respectively. The Modules not only determine the MAC addresses of the detectable APs, but make RSSI measurements of the APs' signals. Module 102 encapsulates the MAC addresses for Location 1 (120) in a three-field DNS request having the following form:
m00000001r70.m00000002r80.m00000003r60.example.com
   Here, “armada.ai” is the domain name of the Location Service Server 112. Similarly, Module 302 encapsulates the MAC addresses for Location 2 (304) in a three-field DNS request having the following form:
m00000004r70.m0000005r75.m00000006r80.example.com
   As an alternative example, additional DNS request packets may be sent to report the RSSIs of the APs. The combination of MAC addresses and RSSI values is herein termed an “AP list.” The particular format of communication encapsulated in the DNS request, and details of DNS protocol, described here is illustrative only, other formats and protocols are contemplated and within the scope of the invention. For example, data other than or additional to MAC addresses and RSSI values may be encapsulated in DNS request packets, or may be encrypted before encapsulation.

The AP list for Location 1 (120) is uploaded from Module 102 to the DNS (“Up data A” arrow 312), and the tunneled AP list for Location 2 (304) is uploaded from Module 302 to the DNS (“Up data B” arrow 316). The AP list transmitted by Module 102 is as follows:

| MAC | RSSI (dBm) |
|---|---|
| 00:00:00:00:01 | −70 |
| 00:00:00:00:02 | −80 |
| 0:00:00:00:03 | −60 |

Similarly, the AP list transmitted by Module 302 is as follows:

| MAC | RSSI (dBm) |
|---|---|
| 00:00:00:00:04 | −70 |
| 00:00:00:00:05 | −75 |
| 00:00:00:00:06 | −80 |

Of note, although data flow to and from each Module occurs through at least one of the APs at each location, for simplicity, exchange between Module and DNS is depicted by a direct arrow. Also of note, any number of Modules can be tracked at any number of Locations, as limited only by the technical capacity of the subsystems of system 300.

The DNS, seeking to resolve the fake (or “custom”) DNS requests from the Modules, and passes them along the DNS hierarchy to the Location Service Server 112 (“Up data” arrow 318). The Location Service Server 112 sends confirmatory DNS response messages to the Modules and passes (“Up data” arrow 320) the AP lists extracted from the received DNS requests to the Location Web Service 322, a software entity that may run on the Location Service Server 112 or elsewhere and whose tasks include communication with the Access Point Locations Server/Database 116, which could be implemented by a third-party service provider. The Location Web Service 322 passes the AP lists (“AP lists” arrow 322) to the Access Point Locations Server/Database 116, which returns a location estimate for each Module (“Location” arrow 324). In an example, a location estimate is returned as a longitude-latitude pair. In another example, location estimate is returned as a longitude-latitude pair and the name of particular a cargo-handling facility. Alternatively, particular facilities might be identified by the Location Web Service 322 from longitude-latitude data using a separate database. Techniques for estimating and providing locations of a mobile device based on information collected for collocated network device(s) are described in U.S. Pat. Nos. 7,403,762 and 7,474,897, which are incorporated by reference in their entirety.

If configuration data and/or other data are to be transmitted to Modules, the Location Web Service 322 encapsulates the data in appropriately addressed DNS reply messages. (The IP addresses of the Modules may be known to the Location Web Service 322.) These DNS reply messages are transmitted to the Location Service Server 112 (“Config” arrow 328), which hands them off to the DNS (“Config” arrow 330), which in turn passes them back to the proper Modules, in this case Module 102 (“Config A” arrow 332) and Module 302 (“Config B” arrow 314). Modules implement the configurations they receive or take other appropriate action (e.g., go to sleep).

It will be clear to persons familiar with the science of data service designs that in various embodiments, information about assets, including journey-so-far mapping, estimates of velocity and arrival time, telemetry of asset properties, alerts of improper movement, and other information, may all be directed in a private manner to clients tracking asset sets. Such information may be classed, dissected, or statistically analyzed by individual asset, asset class, velocity, time of arrival, and other potentially useful criteria. In various embodiments, information derived from non-Module sources (e.g., traffic density maps) may be combined with DNS-tunneled information from Modules to refine some parameter estimates. A system similar to system 100 of FIG. 1 or system 300 of FIG. 2 may be dedicated to tracking the assets of a single user or enterprise, rather than a number of clients.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive. Moreover, the advantages of various embodiments of the invention are not limited to the advantages specifically described herein.

What is claimed is:

1. A system for tracking a mobile asset, comprising:
a module physically coupled to the mobile asset; and
a remote server that communicates with the module via one or more access points providing access to a communication network including a domain name server,
wherein said module i) scans for one or more broadcasts by at least a first access point of the one or more access points, the one or more broadcasts including at least a first broadcast incorporating a first identifier associated with the first access point; ii) determines a first signal strength associated with the one or more broadcasts; iii) encapsulates into one or more domain name system request packets data incorporating the first identifier and the first signal strength; and iv) communicates, using domain name system tunneling, the one or more domain name system request packets to said remote server via the one or more access points and the domain name server, and
wherein said remote server estimates the location of the module based on the data incorporating the first identifier and the first signal strength received in the one or more domain name system request packets.

2. The system of claim 1, wherein said module encapsulates into said one or more domain name system request packets data incorporating the first identifier, a second identifier identifying a second access point, the first signal strength, and a second signal strength corresponding to one or more broadcasts from said second access point; and wherein said remote server estimates the location of the module based on the data incorporating the first and second identifiers and the first and second signal strengths received in the one or more domain name system request packets.

3. The system of claim 1, wherein the module receives one more domain name system return packets incorporating a message to reconfigure said module and reconfigures itself upon receipt of said message.

4. The system of claim 1, wherein the module is coupled to a plurality of sensors that monitor the status of the mobile asset.

5. The system of claim 1, wherein said remote server accesses a database to associate the first identifier with a geographical location corresponding to a location of the first access point that is stored in the database.

6. A method for tracking a mobile asset physically coupled to a module that communicates with a remote server via one or more access points providing access to a communication network including a domain name server, the method comprising the acts of:
scanning, by a module, for one or more broadcasts by at least a first access point of the one or more access points, the one or more broadcasts including at least a first broadcast incorporating a first identifier associated with the first access point;
determining, by the module, a signal strength associated with the one or more broadcasts; encapsulating, by the module, into one or more domain name system request packets data incorporating the first identifier and the signal strength;
communicating, from the module using domain name system tunneling, the one or more domain name system request packets to said remote server via said one or more access points and the domain name server, the remote server being programmed to estimate the location of the module based on the data incorporating the first identifier and the signal strength received in the one or more domain name system request packets.

7. The method of claim 6, wherein the step of encapsulating comprises encapsulating into said one or more domain name system request packets data incorporating the first identifier, a second identifier identifying a second access point, the first signal strength, and a second signal strength corresponding to one or more broadcasts from the second access point; and wherein said remote server is further programmed to estimate the location of the module based on the data incorporating the first and second identifiers and the first and second signal strengths received in the one or more domain name system request packets.

8. The method of claim 6, further comprising receiving, by the module, one more domain name system return packets incorporating a message to reconfigure said module, and reconfiguring, by the module, upon receipt of said message.

9. The method of claim 6, wherein the module is coupled to a plurality of sensors that monitor the status of the mobile asset.

10. The method of claim 6, wherein the remote server is programmed to access a database to associate the first identifier with a geographical location corresponding to a location of the first access point that is stored in the database.

11. In a communication network having a domain name server communicating with one or more access points providing access to the communication network, the domain name server facilitating tracking of a mobile asset physically coupled to a module, a remote server, which communicates with the module via the one or more access points, the remote server comprising:
a domain name system application that performs domain name system tunneling tasks, including de-encapsulating one or more domain name system request packets received from said module via a domain name server and one or more access points, including a first access point, the one or more domain name system requests including data incorporating a first identifier identifying a first access point and a signal strength of one or more broadcasts made by said first access point; and
a location application which estimates a location of the module based on the data incorporating the first identifier and the signal strength received in the one or more domain name system request packets.

12. In the communication network of claim 11, wherein said domain name system application de-encapsulates the one or more domain name system request packets data received from the module, the one or more domain name system request packets incorporating the first identifier, a second identifier identifying a second access point, the first signal strength, and a second signal strength corresponding to one or more broadcasts from said second access point; and wherein said location application estimates the location of the module based on the data incorporating the first and second identifiers and the first and second signal strengths received in the one or more domain name system request packets.

13. In the communication network of claim 11, wherein the domain name system application performs domain name system tunneling tasks, including encapsulating one or more domain name system return packets incorporating a message to reconfigure said module and communicates said domain name system return packets to the module, said module reconfiguring itself upon receipt of the message.

14. In the communication network of claim 11, wherein the module is coupled to a plurality of sensors that monitor the status of the mobile asset.

15. In the communication network of claim 11, wherein said remote server accesses a database to associate the first identifier with a geographical location corresponding to a location of the first access point that is stored in the database.

16. A module configured to track a mobile asset, comprising:
a module programmed to communicate with a remote server via one or more access points that provide access to a communication network including a domain name server, wherein said module i) scans for one or more broadcasts by at least a first access point of the one or more access points, the one or more broadcasts including at least a first broadcast incorporating a first identifier associated with the first access point; ii) determines a first signal strength associated with the one or more broadcasts; iii) encapsulates into one or more domain name system request packets data incorporating the first identifier and the first signal strength; and iv) communicates, using domain name system tunneling, the one or more domain name system request packets to said remote server via the one or more access points and the domain name server; wherein said remote server is programmed to estimate the location of the module based on the data incorporating the first identifier and the first signal strength received in the one or more domain name system request packets.

17. The module of claim 16, wherein said module encapsulates into said one or more domain name system request packets data incorporating the first identifier, a second identifier identifying a second access point, the first signal strength, and a second signal strength corresponding to one or more broadcasts from said second access point; and wherein said remote server estimates the location of the module based on the data incorporating the first and second identifiers and the first and second signal strengths received in the one or more domain name system request packets.

18. The module of claim 16, wherein the module receives one more domain name system return packets incorporating a message to reconfigure said module and reconfigures itself upon receipt of said message.

19. The module of claim 16, wherein the module is coupled to a plurality of sensors that monitor the status of the mobile asset.

20. A computer program product including a non-transitory computer readable storage medium having computer readable program codes embodied therein, the computer readable program codes causing the computer to:
perform domain name system tunneling tasks, including de-encapsulating one or more domain name system request packets received from a module physically coupled to a mobile asset via a domain name server and one or more access points, including a first access point, the one or more domain name system requests including data incorporating a first identifier identifying the first access point and a signal strength of one or more broadcasts made by the first access point; and
estimating a location of the module based on the data incorporating the first identifier and the signal strength received in the one or more domain name system request packets.

21. The computer program product of claim 20, wherein the computer readable program codes further cause the computer to access a database to associate the first identifier with a geographical location corresponding to a location of the first access point that is stored in the database.
